(19) United States
(12) Patent Application Publication
(10) Pub. No.: US 2011/0203671 A1
(43) Pub. Date: Aug. 25, 2011

(54) APPARATUS AND METHOD FOR CONTROLLING THE FLOW OF FLUID IN A VORTEX AMPLIFIER

(76) Inventor: Raymond Doig, Manchester (GB)

(21) Appl. No.: 13/126,161

(22) PCT Filed: Oct. 22, 2009
(86) PCT No.: PCT/GB2009/051425

§ 371 Date: Apr. 26, 2011

(30) Foreign Application Priority Data
Oct. 30, 2008 (GB) 0819927.5

(51) Int. Cl. F15C 1/04

(52) U.S. Cl. 137/1; 137/825

(57) ABSTRACT

A method and apparatus are disclosed for determining fluid flow in a flow path of a vortex amplifier. The method comprises the steps of preventing flow of control fluid in a direction substantially opposite to a primary direction of purge fluid flow in a purge flow path of a vortex amplifier.

### FIELD OF INVENTION

The present invention relates to an apparatus and a method for controlling the flow of fluid in a vortex amplifier. More particularly, but not exclusively, the present invention relates to an apparatus and a method for controlling the flow of a control fluid in a vortex amplifier so as to help minimise leakage of the control fluid.

### BACKGROUND

Extraction systems are well known and commonly used to extract and filter fluids from certain environments.

In certain extraction systems vortex amplifiers (VXAs) are conventionally used to modulate or control the amount of suction extracted by the extraction system. Vortex amplifiers have a number of advantages. Vortex amplifiers have no moving parts and so they are virtually maintenance free. Also, vortex amplifiers are able to react almost instantaneously to changes in the suction line and regulate the amount of suction as required.

Extraction systems which use vortex amplifiers are suitable for use with a containment where the atmosphere within the containment must be kept isolated from the outside environment and the atmosphere must be maintained at a predetermined pressure below atmospheric pressure (commonly known as the containment depression). The extraction systems are used to extract and filter the atmosphere from within the containment and optionally any waste and/or contaminants produced by operations within the containment.

The vortex amplifier of such an extraction system controls the amount of suction extracted from the containment. Under normal operating conditions, the vortex amplifier controls the suction of the extraction system such that the amount of suction extracted from the containment is low and it also helps to maintain the predetermined pressure in the containment. In the case of a small leak, operational characteristics of the vortex amplifier change to increase the amount of suction such that the containment is substantially maintained, although at a slightly smaller depression. Under emergency conditions, when there is a breach in the containment the vortex amplifier significantly increases the amount of suction to help prevent any leaking of the atmosphere etc. from the containment.

A conventional vortex amplifier includes a cover plate, a vortex plate and a diffuser plate. The plates are configured in a spaced apart relationship such that the region between the cover plate and vortex plate defines a vortex chamber and the region between the vortex plate and diffuser plate constitutes a radial diffuser.

The vortex plate includes a central aperture such that fluid can flow from the vortex chamber into the radial diffuser. The vortex amplifier comprises an outlet arranged at the rear of the radial diffuser. The outlet is often arranged in fluid communication with a filtering means of the extraction system, which in turn is arranged in fluid communication with a suction means and an outlet duct of the extraction system

The fluid extracted from a certain environment and filtered by an extraction system is conventionally known as a purge fluid (PF). When the extraction system is used with a containment such as a glove box, the purge fluid includes the atmosphere extracted from within the containment and any waste and/or contaminants produced by operations within the containment. The purge fluid may include components of a gas, liquid, plasma and/or solid material. For example, the purge fluid may comprise a solid entrained in a gas. Additionally or alternatively, the purge fluid may comprise a liquid suspended in a gas. As indicated above, the purge fluid is extracted by the extraction system using suction. The purge fluid is sucked into the vortex chamber of the extraction system via one or more purge fluid ports.

A conventional vortex amplifier further includes one or more control fluid ports to direct a control fluid (CF) from a control fluid source into the vortex chamber. The control fluid is usually, though not always, derived from the atmosphere outside the purge fluid source, e.g. a containment, and so the control fluid is normally a flow of air.

The vortex amplifier is able to control the suction of the purge fluid—in other words, the vortex amplifier is able to regulate the amount of purge fluid extracted by the extraction system. The vortex amplifier regulates the flow rate of the purge fluid by manipulating the length of the flow path of the outgoing purge fluid within the vortex chamber. The length of the flow path of the purge fluid within the vortex chamber is dependent on whether or not the purge fluid is deflected and consequently throttled or resisted by the control fluid. If the purge fluid is deflected by the control fluid then the purge fluid follows a long spiral flow path around the vortex chamber and so the flow rate (and thus amount of suction) of purge fluid through the vortex chamber is low. If the purge fluid is not deflected by a control fluid then the purge fluid follows a shorter direct path through the vortex chamber and the rate of purge fluid flowing through the vortex amplifier (and thus amount of suction) is thereby relatively higher.

Conventionally the control fluid ports of a vortex amplifier are configured (shaped and arranged with respect to an adjacent purge fluid port) such that control fluid emerges from the outlet of the control fluid port and flows in a direction within the vortex chamber such that it deflects and mixes with the flow of the purge fluid. Ideally, all the control fluid drawn into the vortex chamber would be directed to deflect and mix with the purge fluid and subsequently flow through the vortex amplifier to the filtration means etc. of the extraction system. However, it has been found that this does not happen in practice and that control fluid can leak from the vortex amplifier into the containment via the purge fluid ports.

The leaking of control fluid via the purge fluid ports of the vortex amplifier has a detrimental effect on the operation of the extraction system. More specifically, the leakage of control fluid impairs the regulation of the suction of the purge fluid by the vortex amplifier. When the vortex amplifier is part of an extraction system for a containment the leaking of control fluid into the containment is problematic. This problem is particularly serious when the containment is intended to operate in an inert atmosphere mode (i.e. in an atmosphere excluding oxygen) and the control fluid is air drawn from the outside atmosphere.

To date, the problem of leaking control fluid has been overcome by increasing the flow of an inert gas into the containment. However, the costs associated with sufficiently increasing the flow of inert gas are substantial. As an example from the nuclear industry, it is estimated that the cost of sufficiently increasing the flow of nitrogen gas into the containment of a MOX processing plant to counteract the leaking of air from the associated vortex amplifier is approximately £1 million per annum. The increased flow of nitrogen is to maintain the safe level of oxygen to prevent combustion.

In addition to costliness this solution is often unsuitable because the pressure inside the containment will no longer be maintained at a predetermined pressure below atmospheric pressure and so the vortex amplifier will no longer operate under normal operating conditions. The increase in the pressure of the inert gas will change the pressure difference between supply pressure and the control pressure of the vortex amplifier. The change in the pressure difference will reduce the amount of control fluid drawn into the vortex amplifier and lead to an increase in the flow of inert gas through the vortex amplifier, which ultimately leads to an increase in the operating costs of the containment.

It is an aim of the present invention to at least partly mitigate the above-referenced problems.

It is an aim of certain embodiments of the present invention to address or overcome the problem of control fluid leaking from the vortex chamber into the containment. More specifically, it is an aim of these embodiments to control the flow of control fluid and thereby at least reduce or minimise the leaking of control fluid from the vortex amplifier.

It is an aim of certain embodiments of the present invention to seek to counteract the problem of leaking control fluid without impeding the overall performance of vortex amplifier and extraction system. These embodiments seek to control the flow of control fluid and thereby at least reduce the leakage of control fluid from the vortex amplifier without requiring an increase in the flow of purge fluid into the vortex chamber.

### BRIEF SUMMARY OF THE DISCLOSURE

According to a first aspect of the present disclosure there is provided a method for determining fluid flow in a flow path of a vortex amplifier, comprising the steps of:
preventing flow of control fluid in a direction substantially opposite to a primary direction of purge fluid flow in a purge flow path of a vortex amplifier.

According to a second aspect of the present invention there is provided apparatus for determining fluid flow in a flow path of a vortex amplifier, comprising:
a purge flow path along which purge fluid is flowable in a primary direction of purge fluid flow; and
a control flow path along which control fluid is flowable in a further direction of control fluid flow; wherein
the purge flow path and control flow path are arranged to prevent the flow of control fluid in a direction substantially opposite to said primary direction.

Embodiments of the present invention reduce back flow of control fluid into a zone of a containment by ensuring that control fluid ejected from a control port does not experience the Coanda effect as it impacts against a side wall of a purge flow port. Certain embodiments of the present invention achieve this by ensuring that a flow of control fluid exiting a control fluid port is directed in such a direction that fluid flow therefrom wholly avoids impact or is baffled to avoid impact with an outlet of a purge fluid flow path.

Certain embodiments of the present invention provide the advantage that fluid flowing backwards down a purge flow path via the Coanda effect is stripped away from the walls of the fluid flow path. This may be achieved by increasing pressure at a desired region of the outlet.

Certain embodiments of the present invention provide the advantage that fluid flowing backwards down a purge flow path via the Coanda effect has a flow path increased either by providing recesses or protrusions in the side wall of the fluid flow path. As a result the fluid flow path of the control fluid follows a labyrinthine route which reduces overall backwards motion of the control fluid.

Certain embodiments of the present invention reduce or eradicate backward flow of control fluid by a combination of the techniques noted above for reducing control fluid flow.

### BRIEF DESCRIPTION OF THE DRAWINGS

For a better understanding of the present disclosure and to show how it may be carried into effect, reference shall now be made, by way of example only, to the accompanying drawings in which:

FIG. 1 illustrates part of a vortex amplifier;

FIG. 2 illustrates the generation of a vortex;

FIG. 3 illustrates vortex amplifier under emergency conditions;

FIG. 4 illustrates how back flow of control fluid in a purge flow path may be avoided;

FIG. 5 illustrates how back flow of control fluid in a purge flow path may be avoided; and

FIG. 6 illustrates how back flow of control fluid in a purge flow path may be avoided.

### DETAILED DESCRIPTION

Reference will be made hereinafter to the Coanda effect. It is to be noted that the Coanda effect refers to the tendency of fluid in a fluid jet to remain attached to a surface against which a part or a whole of the fluid jet contacts. As a result of the Coanda effect fluid is entrained or caused to “stick” to the contacted surface. Such fluid can flow along the contacted surface against a primary flow direction defined by another fluid flowing along a path defined by the surface.

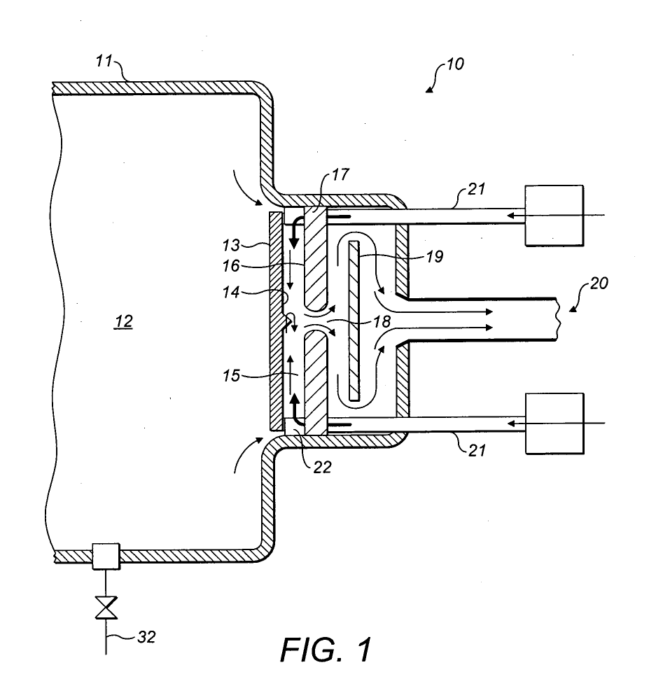

FIG. 1 illustrates a vortex amplifier 10. The vortex amplifier (VXA) is a non-moving part fluidic device that uses the variable resistance offered by a vortex to effect flow changes in an extract line. The VXA is thus a fluidic device that does not have any moving parts and uses differing flow path lengths to bring about a change in resistance offered. This offered resistance is able to modulate fluid flow through it.

A containment 11 which might be a glove box or chemical clean chamber or other such environment is defined by a housing which encompasses a zone 12. Access to the zone 12 may be provided by sealed gloves (for example where the containment is a glove box) or other manipulators as will be appreciated by those skilled in the art. A cover plate 13 has a first surface facing the internal chamber of the containment and a reverse surface 14 which defines a wall of a vortex chamber 15. Another wall of the vortex chamber 15 is defined by an inner surface 16 of a vortex plate 17. The vortex chamber 15 is generally circular and has a central outlet 18 and radial and tangential inlets (described in further detail below). A radial diffuser 19 is provided by a baffling plate to diffuse the radial flow of fluid exiting the vortex chamber. An exit port 20 is used to extract fluid which may then be filtered and is drawn through the vortex chamber from the containment via a power source (not shown) such as an extractor fan.

A supply flow of purge fluid enters the vortex chamber 15 from the containment 12 generally directed and in the absence of a vortex can pass relatively easily through the VXA. A control fluid enters the vortex chamber 15 through control fluid ports along control fluid communication paths 21. The flow of control fluid enters tangentially into the vortex chamber and generates a vortex which causes high resistance to the flow of purge fluid from the containment to the exit port 20. The vortex generated can produce such a high resistance that flow of purge fluid can be substantially reduced or even stopped. A small control flow can thus reduce to zero a supply flow some 10 to 20 times greater. The VXA therefore provides flow amplification and this is often quantified as a “turn down ratio”.

As illustrated in FIG. 1 a flow of purge fluid accesses the vortex chamber 15 around a peripheral edge of the cover plate 13 between the cover plate 13 and the containment housing 11. Control blocks 22 are secured to the downstream surface 14 of the cover plate or maybe integrally formed therewith. Alternatively the control blocks 22 may be secured to an upstream surface 16 of the vortex plate 60 or be integrally formed therewith.

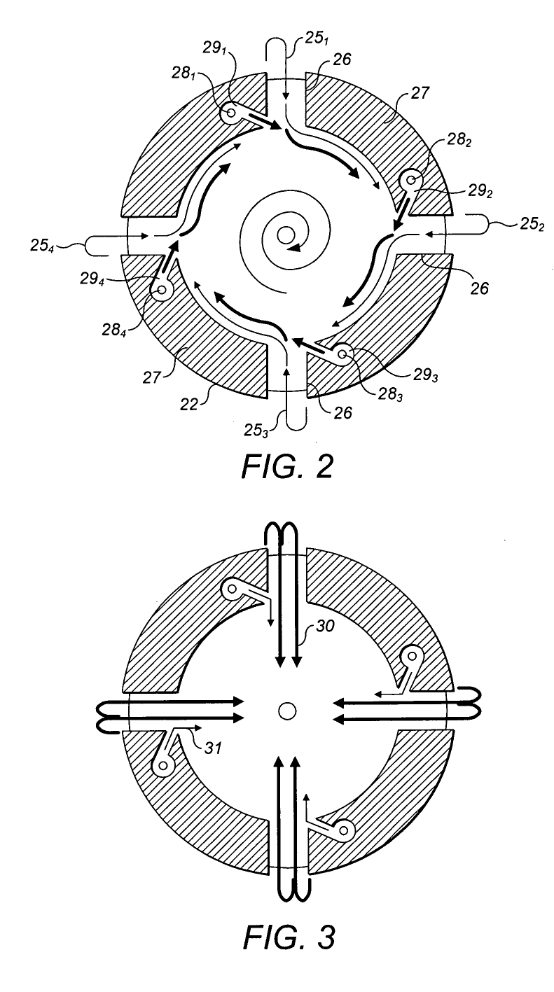

FIG. 2 illustrates a downstream surface 14 of the cover plate 13 and downstream surface of the control blocks 22. As illustrated the cover block in the exemplary embodiment is provided by four sub-plates secured via bolting, adhesive, screwing or any other fastening mechanism to the downstream surface 14 of the cover plate. It will be understood that references to upstream and downstream refer to the flow of fluid from the containment (upstream) to the exit port 20 (downstream). In this sense FIG. 2 shows a view of the downstream surface of the cover plate and control blocks looking towards the glove box from the vortex plate. Fluid flow is shown spiraling in a clockwise vortex and will flow out of the purge away from the reverse of the cover plate through the central outlet 18 in the vortex plate.

As illustrated in FIG. 2 four purge flow inlets 25 1-4 are provided. The purge flow inlets are defined by sidewalls 26 of the raised circumferentially extending parts 27 of the vortex plate. Purge fluid flows from the containment around the periphery of the cover plate between the spaces between the sub-plates 27.

Four control ports 28 are located proximate to an outlet region of each purge flow port. Each control port 28 includes a passageway 21 with an exit passageway 29₁₋₄ formed in the control blocks 22 which is orientated so that control fluid flows from passageway 21 in a direction out of the paper shown in FIG. 2 and then substantially at right angles to flow across the flow of purge fluid at the respective purge flow outlet. Control fluid thus flows tangentially with respect to a flow of purge fluid flow and causes the purge fluid to be entrained in a generally circulating path within the vortex chamber 15. By controlling the flow of control fluid the vortex can be developed or cancelled to produce a respective effect on the flow of purge fluid. As illustrated in FIG. 2, when a generally swirling motion is developed within the vortex chamber a relatively high resistance is offered to purge fluid flow into the vortex chamber. This is typical of a situation when the containment is operating normally.

FIG. 3 illustrates a scenario when the containment is breached. Under these conditions control fluid flow is reduced so that a swirling vortex is not developed within the vortex chamber. As a result little resistance is offered to the flow of purge fluid outwards from the containment. This is illustrated in FIG. 3 by the larger, darker arrows 30 illustrating a major flow of fluid through the purge fluid outlets into the centre of the vortex chamber where they are extracted through a central opening 18 via the one or more extraction fans. As illustrated in FIG. 3 under such circumstances the relative flow of control fluid is weak in comparison to the flow of purge fluid flow. This is illustrated by thin arrows 31. Such a scenario occurs when a breach in the containment occurs in which circumstances a large quantity of purge fluid is continually sucked from an inlet 32 illustrated in FIG. 1 through the inner zone 12 of the housing 11 through openings in the control port cover plate and through the vortex chamber and central opening in the vortex plate.

As noted above, it has now been appreciated that a flow of control fluid must be avoided against the normal flow of purge fluid incoming through the purge fluid inlets 25. It has now been appreciated that with conventional vortex amplifiers the spray of control fluid exiting conventional control fluid outlets has at least partially impacted against an opposite surface 26 defining the purge fluid flow inlet. As a result of the Coanda effect control fluid impacting in this way has been entrained against the surface and has flowed along that surface against the primary flow direction defined by the flow of purge fluid. In this way with conventional vortex amplifiers control fluid has found its way into the zone 12 of the containment.

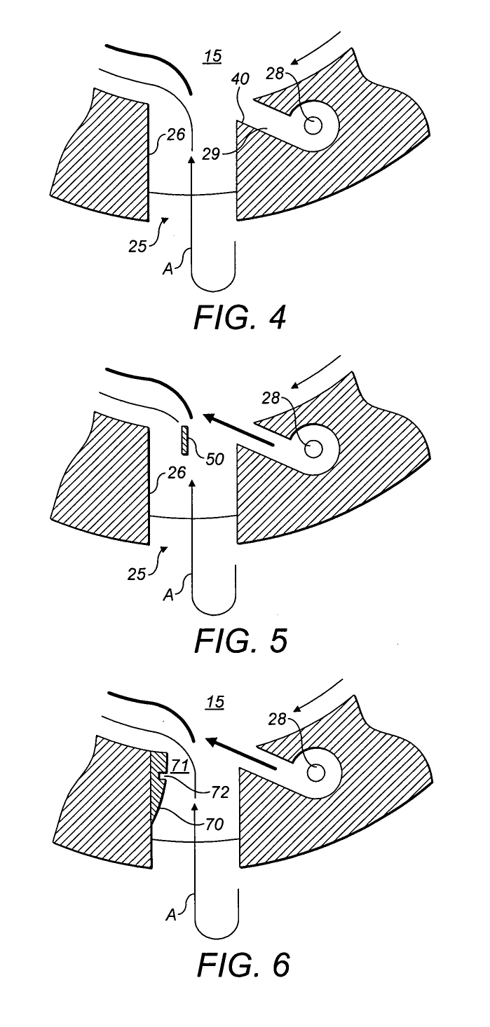

FIG. 4 illustrates the vortex amplifier of FIGS. 1 to 3 in more detail according to a first embodiment of the present invention. As illustrated in FIG. 4 purge fluid flows in a primary direction illustrated by the direction of arrow A through the purge flow inlet port 25 and then on to the vortex amplifier chamber 15. A control fluid port 28 is used to eject control fluid along a control fluid passageway 29 defined by side walls 40. The shape and orientation of the side walls 40 are defined during the design of the vortex amplifier so that the spray of control fluid ejected into the vortex amplifier chamber 15 does not impact whatsoever or only to a very limited degree onto the opposite side wall 26. In this way no control fluid ejected from the control fluid port 28 impacts on the side wall and is thus not entrained against that side wall so as to move in a direction opposite to the direction illustrated by A in FIG. 4. The side walls are of course directed in such a way that a vortex can be established in the vortex chamber.

FIG. 5 illustrates an alternative embodiment of the present invention in which the exit passageway from the control fluid port 28 is arranged in a direction which might result in ejected control fluid spray impacting at least partially into the opposite surface 26 of the purge fluid flow outlet. To avoid such contact a baffle 50 is located in the purge fluid flow path. The baffle 50 presents a narrow cross section to the purge fluid flow path but presents a greater cross sectional surface against the ejected spray of control fluid. It will be appreciated that the position and size of the baffle element 50 is such that the development of a vortex in the vortex chamber 15 by virtue of ejecting control fluid from the control fluid port is not prevented. The baffle may extend outwardly from a surface of the vortex plate or may be held by one or more struts (not shown) extending to the surface 26.

FIG. 7 illustrates an alternative embodiment of the present invention in which a shaped deflecting surface is provided at a location on the side wall 26 against which control fluid being ejected from the control fluid port 28 will hit. During use control fluid is sprayed out of the control fluid port 28 in order to set up the swirling vortex in the vortex chamber 15. It is appreciated that in this embodiment at least a portion of this control fluid will impact against the opposite surface of the purge fluid outlet. In order to prevent such fluid impacting the side wall and being entrained on the side wall the side wall is shaped so as to generally narrow the passageway along which the purge fluid flows in the direction of arrow A. It will be appreciated that the narrowing can be produced by using a tapered surface 70. The narrowing results in a steadily increasing pressure towards the exit region 71 of the purge fluid flow inlet. This steadily increasing pressure results in any fluid entrained by the Coanda effect being stripped away from the surface 70.

As illustrated in FIG. 7 the tapered surface 70 may optionally include one or more recesses 72. This also reduces or prevents flow of control fluid in a direction opposite to direction A by substantially increasing the length of flow path for such fluid flow. Effectively a labyrinthine path is produced. Control fluid may be caused to collect in the bottom of the recess.

Optionally, instead of or in addition to the recess 72, a prominent protuberance may be included extending outwardly from the surface of the side wall. This also increases pressure in the purge fluid outlet which will ensure the purge fluid flow flowing into the vortex chamber strips away any entrain control fluid. Also a labyrinthine path for control fluid flow is established.

It will be appreciated that any combination of the tapered inlet, recess, protuberance, baffle and/or angled control fluid port may be used so as to minimise or eradicate backward flow of control fluid into the containment.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A method for determining fluid flow in a flow path of a vortex amplifier, comprising the steps of:
preventing flow of control fluid in a direction substantially opposite to a primary direction of purge fluid flow in a purge flow path of a vortex amplifier.

2. The method as claimed in claim 1, wherein the step of preventing comprises the steps of:
preventing flow of control fluid, entrained via the Coanda effect, in the purge flow path in a direction substantially opposite to the primary direction of purge fluid flow.

3. The method as claimed in claim 1, further comprising the steps of:
preventing said flow of control fluid via a flow directing surface of the purge flow path.

4. The method as claimed in claim 3 further comprising the steps of:
preventing impact of control flow fluid with a side wall region of a purge fluid outlet region via a baffle extending between the side wall and a control port.

5. The method as claimed in claim 3 further comprising the steps of:
increasing pressure and/or flow rate in an outlet region of the purge flow path proximate to an exit orifice of the purge flow path.

6. The method as claimed in claim 3 further comprising the steps of:
directing control fluid flow away from a side wall region of an outlet region of the purge flow path.

7. The method as claimed in claim 3 further comprising the steps of:
directing control fluid flow away from a side wall of an outlet region of the purge flow path and increasing pressure and/or flow rate in an outlet region of the purge flow path towards an exit orifice of the purge flow path.

8. The method as claimed in claim 5 wherein the pressure and/or flow rate is increased gradually in the outlet region towards the exit orifice.

9. The method as claimed in claim 1, further comprising the steps of:
directing a flow of control fluid, via a control fluid outlet passage, in a direction that avoids control fluid exiting the outlet passage impacting with a side wall region of a respective purge flow path.

10. The method as claimed in claim 1, further comprising the steps of:
preventing flow of control fluid upstream in each of a plurality of purge flow outlets of the vortex amplifier.

11. Apparatus for determining fluid flow in a flow path of a vortex amplifier, comprising:
a purge flow path along which purge fluid is flowable in a primary direction of purge fluid flow; and
a control flow path along which control fluid is flowable in a further direction of control fluid flow; wherein
the purge flow path and control flow path are arranged to prevent the flow of control fluid in a direction substantially opposite to said primary direction.

12. The apparatus as claimed in claim 11, further comprising:
the purge flow path and control flow path are arranged to prevent flow of control fluid, entrained via the Coanda effect, in the purge flow path in a direction substantially opposite to the primary direction of purge fluid flow.

13. The apparatus as claimed in claim 11, further comprising:
the purge flow path comprises a flow directing surface that prevents said flow of control fluid in a direction opposite to said primary direction.

14. The apparatus as claimed in claim 13, further comprising:
the flow directing surface comprises at least one baffle element in an outlet region of the purge flow path.

15. The apparatus as claimed in claim 13, further comprising:
the flow directing surface comprises at least one recess in a side wall of an outlet region of the purge flow path.

16. The apparatus as claimed in claim 13, further comprising:
the flow directing surface comprises a tapered side wall of an outlet region of the purge flow path, the tapered side wall tapering generally inwardly towards an exit orifice of the outlet region.

17. The apparatus as claimed in claim 13, further comprising:
the flow directing surface comprises a tapered side wall of an outlet region of the purge flow path, the tapered side wall tapering generally inwardly towards an exit orifice of the outlet region and at least one recess in the tapered side wall.

18. The apparatus as claimed in claim 13, further comprising:
the control flow path comprises a control fluid outlet passage that is arranged to direct control fluid in a direction that avoids control fluid exiting the outlet passage impacting with a side wall of the purge flow path.

19. A vortex amplifier comprising the apparatus as claimed in claim 11.

20. The vortex amplifier as claimed in claim 19, further comprising:
a plurality of purge flow paths each associated with a respective control flow path arranged to direct purge fluid in a common spiral path.

21. (canceled)

22. (canceled)
